(19) United States
(12) Patent Application Publication
(10) Pub. No.: US 2004/0130522 A1
(43) Pub. Date: Jul. 8, 2004

(54) System and method for presenting real handwriting trace

(76) Inventors: Wen-Po Lin, Tainan City (TW); Ting-Shan Cheng, Hsin-Chu (TW)

Correspondence Address: LAW OFFICES OF CLEMENT CHENG, 17220 NEWHOPE STREET #127, FOUNTAIN VALLEY, CA, 92708, US

(21) Appl. No.: 10/338,572

(22) Filed: Jan. 8, 2003

(51) Int. Cl. G09G 5/00

(52) U.S. Cl. 345/156; 382/186; 345/700

(57) ABSTRACT

This present invention discloses a system and a method for presenting a real handwriting trace. The design of this invention can keep the real handwriting traces of the users and transmit the real handwriting traces to application software. Moreover, the prior trace identifying process is not necessary in this invention. Thus, the design of this invention does not have to spend time on the trace identifying process, and the mistakes during the trace identifying process can be avoided. Hence, this present invention can provide a system and a method for directly inputting traces into a file of application software by handwriting or hand-drawing. Preferably, according to this invention, the real traces of the users can be presented on the file of application software.

### BACKGROUND OF THE INVENTION

1. Field of the Invention

This present invention relates to a system and a method for handwriting input, and more particularly, to a system and a method for presenting the real handwriting trace.

2. Description of the Prior Art

With the development in technology, input by the prior keyboard or mouse is not the only way for communication between a user and a computer. Particularly to some special users, input with handwriting or hand-drawing traces through a tablet is another new choice and convenient way to communicate with a computer.

Through the current handwriting input programs, the users handwriting trace will be identified and transferred into the correlated printed characters. However, the above-mentioned handwriting input programs cannot display the real handwriting trace with the character of a user. Besides, some current application software, such as MS-paint, can provide a function that a user can input simple lines by the painting tools thereof, but the real handwriting trace of a user still cannot be shown by the above-mentioned application software. In other words, the current application software for handwriting input cannot provide the function for a user to input the real handwriting trace with a user's personal character.

Hence, it is an important object of this invention to provide a system and a method for presenting the real handwriting trace of a user.

### SUMMARY OF THE INVENTION

In accordance with the present invention, a system and a method for presenting the real handwriting trace of a user is provided for a user to perform handwriting input, and present the real handwriting trace in any application software.

It is another object of this invention to provide a system and a method for presenting the real handwriting trace. According to this invention, the real handwriting trace of a user can be shown on a file for application software, such that a user can performadditions, such as handwriting signing, handwriting inputting, and hand-drawing, on the file of application software with the personal handwriting trace.

It is a further object of this present invention to provide a system and a method for presenting the real handwriting trace on E-mails, so that the E-mails can display the personal character. Moreover, the E-mails according to this invention will not become unreadable by the receivers, even if the language families are different between the E-mail writer and the E-mail receiver.

It is still a further object of this present invention to provide a system and a method for presenting the real handwriting trace on presentation software, such that the real handwriting traces that can be employed for enhancement, highline, or other auxiliary tools during a presentation.

It is still a further object of this present invention to provide a system and a method for presenting the real handwriting trace. This invention can automatically judge and choose the suitable way to output the real handwriting trace into a application software file.

In accordance with the above-mentioned objects, this invention provides a system and a method for presenting real handwriting traces. According to this invention, real handwriting traces input-on a tablet will pass through a trace processing and output to a file of application software. The above-mentioned application software may be office software, presentation software, E-mail tool software, drawing/painting software, or other application software. Therefore, this invention can be employed to retain the real handwriting trace of a user and transmit the real handwriting trace to a file of application software. Thus, a user can employ the real handwriting trace to edit the application software file.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a flowchart of a system for presenting real handwriting trace according to this invention;

FIG. 2 shows a block diagram of a system for presenting real handwriting trace according this present invention; and

FIG. 3 shows a flowchart of a method for presenting real handwriting trace according to this invention.

### DESCRIPTION OF THE PREFERRED EMBODIMENTS

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

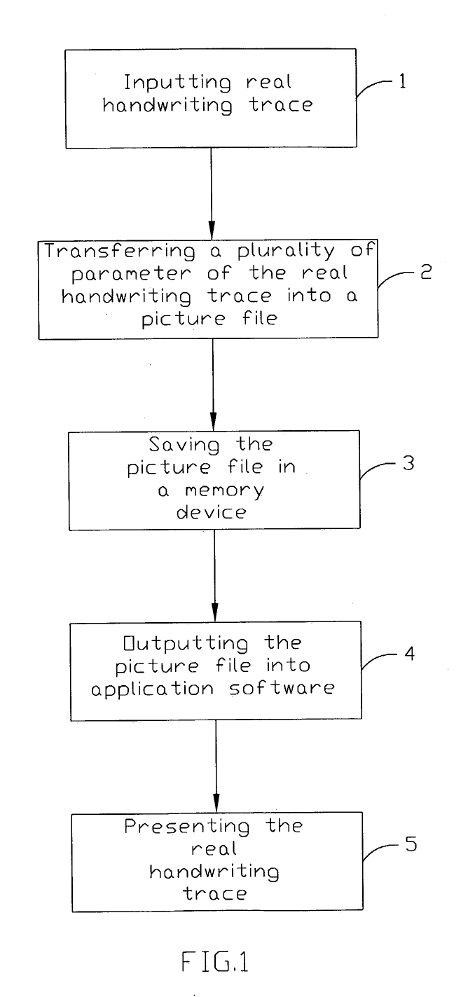

One preferred embodiment of this invention is a system for presenting real handwriting traces. FIG. 1 shows a flowchart of a system for presenting real handwriting traces according to this embodiment. When a user inputs a handwriting trace into a tablet, such as words or drawings, as shown in the step 1, the tablet can receive the information of the real handwriting or hand-drawing traces. After a trace processing, the real handwriting trace is transferred to a picture file, as shown in step 2, and saved in a memory device, as the step 3. Then, the picture file is output to a file of application software, as the step 4. Finally, the real handwriting trace can be presented on the application software file by a displayer.

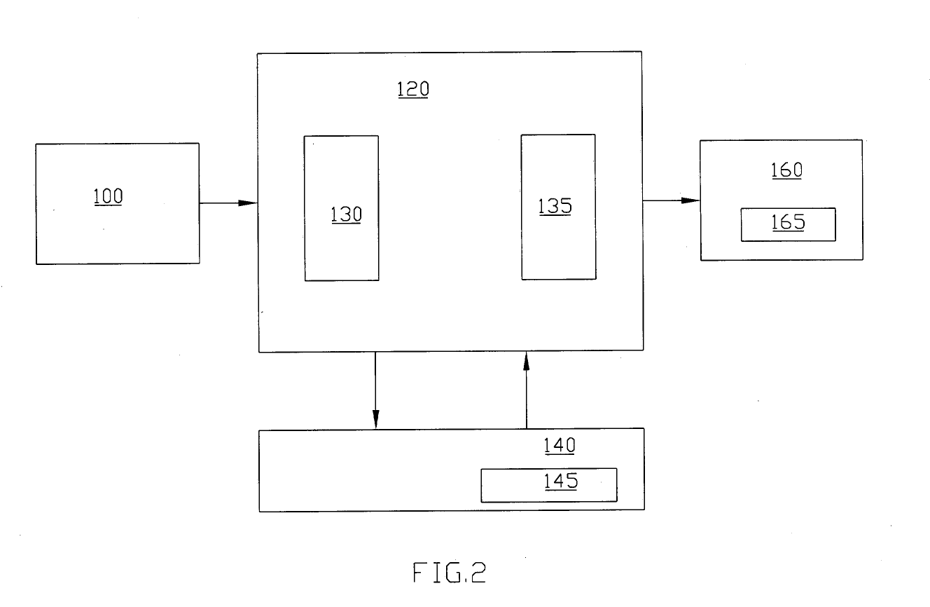

FIG. 2 is the block diagram of the system for presenting real handwriting trace according to this embodiment. When inputting words or drawings by handwriting or hand-drawing on an inputting device 100, the inputting device will transmit the correlated parameters of the real handwriting trace to a system-device communication interface 120. The inputting device may comprise a pen-like device and a tablet. The above-mentioned parameters will be transferred into a picture file. The picture file will be saved in a blank photo black 145 of a memory device 140.

In this embodiment, the system-device communication interface 120 comprises a Wintab interface 130 and a trace processing 135. The Wintab interface 130 is employed to receive a plurality of parameters, of the real handwriting traces from the inputting device 100. The parameters comprise the absolute coordinate data, the pressure data, and other information correlated of the real handwriting trace. After the calculation of the trace processing 135, the parameters are transferred into a picture file and saved in the memory device 140.

Subsequently, the picture file is read from the memory device 140 and output into application software 165 of a working system 160 through a transmission system, not shown in the figure. Finally, the real handwriting trace can be embedded or pasted into a file of application software 165, and presented on a displayer.

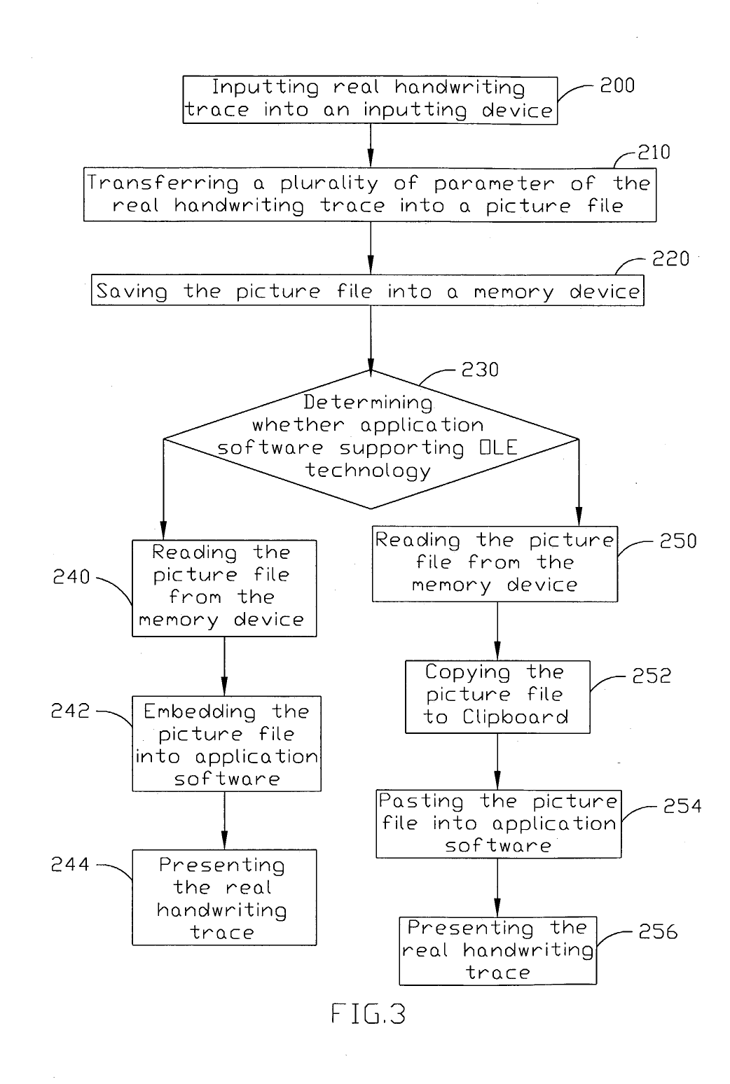

Another preferred embodiment of this present invention is a method for presenting a real handwriting trace. FIG. 3 shows a flowchart of the method for presenting a real handwriting trace according to this embodiment. The above-mentioned method at least comprises an inputting device with a pen-like device and a tablet. The inputting device is employed to receive a plurality of parameters of the real handwriting traces, as the step 200. The real handwriting traces may comprise words or drawings input by a user. The parameters are calculated through a trace processing and transferred into a picture file, as the step 210. The picture file can be saved in a memory device with the real handwriting trace with a user's character, as the step 220. Before outputting the picture file into application software, the method of this embodiment further comprises a step for determining whether the application software supporting the technology of object linking and embedding (OLE), as the step 230.

The application software mentioned in this embodiment comprises the application software supporting OLE technology, and the application software not supporting OLE technology. If the application supports OLE technology, such as Microsoft Office software or some application software of Linux, the picture file can be read from the memory device and embedded into a file of the application software by the technology of OLE, as the steps 240 and 242. Thus, the words or drawings with the real handwriting trace can be output and edited in the file of the application software, and presented on a displayer.

If the application does not suppor OLE technology, the picture file may be output into a file of the application software by the clipboard technology. As shown in steps 250 to 254, the picture file is copied to a clipboard, and then pasted from the clipboard into a file of the application software. Finally, the real handwriting trace of a user can be presented on the file of the application software by a displayer, as step 256.

In one case according to this invention, a plurality of parameters of the real handwriting trace, such as the absolute coordinate data, and the pressure data during writing, are considered while the real handwriting trace is transferred into the picture file in the trace processing. Therefore, the picture file can present the real trace and the writing power of the user, and the trace in the picture file can closely display the personal character of the user. Moreover, the trace processing can modify the real handwriting trace of the user, and thus the trace in the picture file will become smoother.

In another embodiment of this invention, the above-mentioned system and method for presenting a real handwriting trace can be applied on the E-mail tool software. At first, the contents of an E-mail can be input on an inputting device through handwriting or hand-drawing. After a trace processing as mentioned, the contents will be transferred into a picture file and saved in a memory device.

Next, the system for presenting a real handwriting trace can free-note an E-mail tool software in the working system. After creating a new E-mail, the picture file is automatically read from the memory device and attached to the new E-mail. Thus, when the new E-mail is delivered, the contents with the real handwriting trace of the user can be sent to the receiver of this new E-mail.

The parameters, such as the absolute coordinate data and the pressure data of the handwriting trace, are taken by a communication interface as the Wintab Library and calculated during the transfer of the real handwriting trace into a picture file. Thus, the real handwriting trace of the user can be presented in the picture file. Preferably, by the above-mentioned design, the real handwriting trace can be presented as the trace of a Chinese writing brush. That is, the above-mentioned design can present the personal writing/drawing characters of users. Furthermore, through trace processing, the real handwriting trace from the inputting device can be modified, and a smoother handwriting trace can be saved in the picture file.

Besides, according to this embodiment, the contents and the background of the E-mail can be transferred in to a picture file and attached to the E-mail for delivery. The formation of the picture file comprises JPG, GIF, TIFF, BMP, PCX, IMG, and others. The above-mentioned picture file can be delivered with the E-mail. If the receiver's E-mail tool software comprises the preview function; the receiver can read the E-mail with the real handwriting trace of the writer without any other software. That is, according to this invention, it is convenient for a receiver to read an E-mail with the real handwriting trace of the writer.

Compared with the prior technology, the current E-mail tool software cannot provide the function for a user to deliver an E-mail with the real handwriting trace. A user only can write an E-mail through a keyboard. However, if the users are not familiar with the keyboard functions, it is inconvenient for a user to write an E-mail with a keyboard. By the design of this invention, a user can write an E-mail as comfortable as writing letters on a paper.

Moreover, during the prior E-mail delivery, if the language families of the writer and the receiver are not the same, especially for the language families of Asia, some E-mail's may be unable to be read or transferred into different codes and symbols at the end of the receiver. According to this invention, the contents with the real handwriting trace of the E-mail are attached as a picture file, such as JPG picture file, thus the E-mail of this invention is still readable even if the language families of the writer and the receiver are different. Preferably, all the real handwriting traces of a user are retainable in the E-mail according to this invention. Furthermore, a user can add the personal signing on the E-mail in this invention. Therefore, the E-mail according to this invention can keep the personal characters of the writer, and the receiver can feel the friendliness when reading the E-mail of this invention.

Another preferred Embodiment of this invention is a system for presenting the real handwriting trace in presentation software, such as in Microsoft Power Point. Generally, the files of Power Point during a presentation are only read. When a user wants to add some notes for further annotation, the user should click the right button of a mouse to choose the functions in the pop-up menu. However, in the prior design, it is complexity and inconvenient for a user to add further annotation in a file of Power Point.

According to this embodiment, a tablet can be employed as the inputting device for words and drawings. Clicking the right button of a mouse can open a pop-up menu with several annotation functions. According to this embodiment, during a presentation, a user can open another blank document for further annotations. According to the function chosen by the user, the above-mentioned annotation can be embedded into Power Point, and performed by Power Point. It is noted that the words or drawings of the annotation during the presentation will not be saved into the Power Point file after the presentation. That is, all of the annotations during the presentation will not change the contents of the original Power Point file, or other presentation application software files.

Preferably, if necessary, the lines and the color of the real handwriting trace can be changed while presented on the file of the application software or on a displayer. In other words, according to this invention, the real handwriting trace may be presented as the trace of a Chinese writing brush, a pen, a pencil or other writing instruments. Besides, the color of the real hand writing trace can be black, blue, red, or other colors.

Compared with the prior application software, the prior application software cannot present the real handwriting trace of users. The prior application software does not provide the handwriting inputting function. The prior application software can only paint some simple lines with a mouse by the built-in painting tools, such as MS-Paint tool. With the above-mentioned painting tools, the handwriting inputting trace is presented with the correlated coordinated data, thus the presented trace cannot be close to the real handwriting trace of the users. Moreover, the current painting tools, and other inputting software with handwriting, cannot provide the pressure degree function. Thus, the presented trace is shown in a single style of writing or drawing. Furthermore, the current painting tools and inputting software cannot provide trace processing to modify the handwriting trace, and thus the edges of the presented trace are saw-toothed.

On the other hand, the current inputting software with handwriting, transfers the handwriting trace of a user into a printing character, and the real handwriting trace cannot be presented. The discerning powers of all the handwriting inputting software on the market are different. The current handwriting software spends lots time on discerning the real handwriting trace of a user. If the handwriting trace of a user is scratchy or illegible, the current handwriting software frequently makes mistakes, and costs lots of time. However, according to this invention, the real handwriting trace is retained and output into application software. Thus, the time discerning can be saved, and the mistakes in discerning can be avoided.

Hence, the users real handwriting traces can be completely retained by the design of this invention. Moreover, the power during handwriting input can also be presented, and thus the trace shown in the application software file may be closer to the real handwriting trace of the users. Preferably, according to this invention, the real handwriting traces of the users, including the words and drawings, can be output to other application software, and it is convenient for a user to perform the handwriting functions, such as inserting contents, annotations, personal signatures in other application software.

According to the preferred embodiments, this invention discloses a system and a method for presenting real handwriting traces. The above-mentioned system for presenting real handwriting traces comprises an inputting system, a system-device communication interface coupled with the inputting system, and a working system linked to the system-device communication interface. The inputting device is employed for handwriting input of the real handwriting traces, including words and drawings. The system-device communication interface is employed for receiving the real handwriting traces from the inputting system, and transferring the real handwriting traces into a picture file. The above-mentioned system for presenting real handwriting traces may further comprise a memory device for saving the picture file. The picture file can be transmitted into a file of the application software of the working system. This invention further comprises a method for presenting the real handwriting trace. After inputting the real handwriting trace into an inputting device, a plurality of parameters when the real handwriting trace is transferred into a picture file by a trace processing. The picture file may be saved in a memory device. Before outputting the picture file into the application software, a program is employed to determine whether the application software supports the objects linking and embedding technology. If the application software supports the object linking and embedding technology, the picture file is read from the memory device, and embedded into a file of the application software by object linking and embedding technology. If the application software does not support the object linking and embedding technology, the picture file is read from the memory device, copied into a clipboard, and pasted into a file of the application software by clipboard technology. Hence, according to this invention, the real handwriting trace of users can be output and presented in any application software.

Although specific embodiments have been illustrated and described, it will be obvious to those skilled in the art that various modifications may be made without departing from what is intended to be limited solely by the appended claims.

What is claimed is:

1. A system for presenting real handwriting trace, comprising:
an inputting device;
a system-device communication interface coupled with said inputting device, wherein said system-device communication interface is employed to receive a plurality of parameter of the real handwriting trace from said inputting device and transfer said parameters into a picture file; and
a working system linked to said system-device communication interface, wherein said system-device communication interface is employed to output said picture file into an application software and thus the real handwriting trace is presented in a file of said application software.

2. The system according to claim 1, wherein said parameters comprise absolute coordinate data.

3. The system according to claim 1, wherein said parameters comprise pressure data.

4. The system according to claim 1, wherein said picture file is output into said file by object linking and embedding technology.

5. The system according to claim 1, wherein said picture file is output into said file by clipboard technology.

6. The system according to claim 1, wherein said system-device communication interface comprises Wintab interface.

7. The system according to claim 1, wherein said system-device communication interface further comprises a memory device for saving said picture file.

8. The system according to claim 1, wherein said application software is office software.

9. The system according to claim 1, wherein said application is drawing software.

10. The system according to claim 1, wherein said application software is E-mail tool software.

11. A system for presenting real handwriting trace, comprising:
an inputting system for inputting said real handwriting trace;
a system-device communication interface coupled with said inputting system, wherein said system-device communication interface is employed for receiving and transferring a plurality of parameter of said real handwriting trace into a picture file;
a memory device linked to said system-device communication interface, wherein said memory device is employed for saving said picture file; and
a working system linked to said system-device communication interface, wherein said working system is employed for outputting said picture file into an application software and presenting said real handwriting trace in a file of said application software.

12. The system according to claim 11, wherein said parameters comprise absolute coordinate data.

13. The system according to claim 11, wherein said parameters comprise pressure data.

14. The system according to claim 11, wherein said system-device communication interface comprises Wintab interface.

15. The system according to claim 11, wherein said system-device communication interface comprises a trace processing.

16. The system according to claim 11, wherein said picture file is output into said application software by object linking and embedding technology.

17. The system according to claim 11, wherein said picture file is output into said application software by clipboard technology.

18. A method for presenting real handwriting trace, comprising:
inputting real handwriting trace into an inputting device;
transferring a plurality of parameter of said real handwriting trace into a picture file;
outputting said picture file into a file of an application software; and
presenting said real handwriting trace.

19. The method according to claim 18, wherein said parameters comprise absolute coordinate data.

20. The method according to claim 18, wherein said parameters comprise pressure data.

21. The method according to claim 18, further comprising a step for saving said picture file into a memory device after transferring said real handwriting trace into said picture file.

22. The method according to claim 18, further comprising a step for determining whether said application software supporting object linking and embedding technology.

23. The method according to claim 22, wherein said picture file is embedded into said file of said application by object linking and embedding technology when said application supporting object linking and embedding technology.

24. The method according to claim 22, wherein said picture file is pasted into said file of said application by clipboard technology when said application not supporting object linking and embedding technology.
